(19) United States
(12) Patent Application Publication
(10) Pub. No.: US 2013/0158946 A1
(43) Pub. Date: Jun. 20, 2013

(54) MODELLING OF HAND AND ARM POSITION AND ORIENTATION

(71) Applicants: Hansjörg Scherberger, Gottingen (DE); Stefan Schaffelhofer, Gottingen (DE)

(72) Inventors: Hansjörg Scherberger, Gottingen (DE); Stefan Schaffelhofer, Gottingen (DE)

(21) Appl. No.: 13/816,581

(22) PCT Filed: Aug. 10, 2011
(86) PCT No.: PCT/EP11/63771

§ 371 Date: Feb. 12, 2013

Related U.S. Application Data
(60) Provisional application No. 61/373,432, filed on Aug. 13, 2010.

(30) Foreign Application Priority Data
Aug. 13, 2010 (DE) 10172813.7

(51) Int. Cl. G01B 7/00; G06F 17/00

(52) U.S. Cl. CPC G01B 7/00; G06F 17/00
USPC 702/151

(57) ABSTRACT

The present invention provides a method for modelling a position and orientation of a hand with as small a number of sensors as possible. A first sensor is attached on a phalanx distalis of a finger. The first sensor is adapted to provide information on at least five degrees of freedom that correspond to three translations, yaw and pitch. A second sensor is placed at a fixed position relative to a dorsum or palm of the hand. The second sensor is adapted to provide information on at least six degrees of freedom that correspond to three translations, yaw, pitch and roll with respect to a point of the dorsum or palm of the hand. A position and orientation of each of the first and second sensors is detected. A first distance between said point and a metacarpal-phalangeal joint of the finger, a second distance between the metacarpal-phalangeal joint and a proximal interphalangeal joint, a third distance between the proximal interphalangeal joint and a distal interphalangeal joint, and a fourth distance between the distal interphalangeal joint and the first sensor are measured. A position and orientation of each of the three joints is calculated on the basis of the measured first to fourth distances, the detected position and orientation of the first sensor, and the detected position and orientation of the second sensor.

### TECHNICAL FIELD

The present invention relates to a method and system for modelling a position and orientation of a primate hand and arm.

### BACKGROUND OF THE ART

Finger movements are highly complex. Therefore, humans spend much of their childhood learning to use their hands. Holding and moving objects of different size, shapes and weight is part of our early life, but the biomechanic system enabling these movements is highly sophisticated. The human hand as well as the hand or macaque monkeys are able to use 29 degrees of freedom. This fact and the wide range of motion (see Table below) allow primates to perform complex grasp types.

TABLE
Range of motion of a human hand (C. Youngblut, R. E. Johnston,
S. H. Nash et al., “Review of virtual environment
Interface technology,” I.f.D. Analyses, ed., 1996)
(MCP: metacarpal-interphalangeal joint, PIP: proximal-
interphalangeal joint, IP: interphalangeal-joint)

| Joint | Motion | Range |
|---|---|---|
| Thumb | Palmar Adduction | 90° |
| | Radial Abduction | 80-90° |
| | Opposition | 90° |
| | MCP Flexion | 50° |
| | PIP Flexion | 80° |
| Digits | Abduction/Adduction | ±15° |
| | Index MCP Flexion | 86-90° |
| | Index MCP Extension | 22-45° |
| | Index IP Flexon | 100-110° |
| | 2nd finger MCP | 91° |
| | Flex. | |
| | 2nd finger MCP Ext. | 18° |
| | 2nd finger IP | 105° |
| | Flexion | |

The human hand consists of 27 bones as illustrated in FIG. 1. The carpus account for 8, the metacarpus or palm contains five; the remaining fourteen are digital bones: fingers and thumb. The joints connecting them are named meracarpal-phalangeal joints, proximal-interphalangeal joints and distal-interphalangeal joints. The only movements permitted in the interphalangeal joints are flexion and extension, whereas the metacarpal-phalangeal joint is also able to perform adduction and abduction. The most versatile finger is the thumb, which is capable of bending in such a way that it can touch all the other digits on the hand. The opposable thumb is reserved to the primate species.

There have been known various tracking systems for tracking a position and/or an orientation of an orientation such as hand.

For example, a glove for measuring hand kinematics is known, wherein a flex sensor in the form of a strip adapted to change their impedance in proportion to the strain are provided, so that the angle of the finger joint can be evaluated (Simon A. Overduin et al. “An instrumented glove for small primates”, Journal of Neuroscience Methods, 187 (2010) p100 to 104). However, such a strip has to be provided under and above each joint. It is to be noted that this glove provides the angle values but does not provide information on the positions in 3D space.

The object of the present invention is to provide a method and system for modelling a position as well as an orientation of a hand, i.e. the positions and orientations of the finger joints with as small a number of sensors as possible.

### DISCLOSURE OF THE INVENTION

In an aspect of one present invention, a method for modelling a position and orientation of a hand, includes the step of attaching at least a first sensor on a phalanx distalis of a finger. The first sensor is adapted to provide information on at least five degrees of freedom that correspond to three translations, yaw and pinch. A second sensor is placed at a fixed position relative to a dorsum or palm of the hand. The second sensor is adapted to provide information on at least six degrees of freedom than correspond to three translations, yaw, pitch and roil with respect to a point of the dorsum or palm of the hand. A position and orientation of each of the first and second sensors is detected. A first distance between said point and a metacarpal-phalangeal joint of the finger, a second distance between the metacarpal-phalangeal joint and a proximal interphalangeal joint, a third distance between the proximal interphalangeal joint and a distal interphalangeal joint, and a fourth distance between the distal interphalangeal joint and the first sensor are measured. A position and orientation of each of the three joints is calculated on the basis of the measured first to fourth distances, the detected position and orientation of the first sensor, and the detected position and orientation of the second sensor.

In one embodiment, the first sensor has a sensor coil with its axis being placed along a longitudinal direction of the finger. The second sensor has two sensor coils with their axes being placed in a geometrically defined position to each other so that the second sensor provides information on a roll of said point. A varying magnetic field is generated so that the first and second sensors induce voltages, so that at the detection step the position and orientation of each of the first and second sensors is detected cased on the induced voltages.

To simplify the construction, the second sensor is preferably arranged on the dorsum or palm of the hand.

In a further aspect of the present invention, a system for modelling a position and orientation of a hand includes a glove with glove fingers and a modelling device. The glove includes at least a first sensor on a portion of the glove finger corresponding to a phalanx distalis of a finger. The first sensor is adapted to provide information on at least five degrees of freedom that correspond to three translations, yaw and pitch. The glove is also provided with a second sensor at a position that is fixed on a portion of the glove finger corresponding to a dorsum or palm the hand. The second sensor is adapted to provide information on at least six degrees of freedom that correspond to three translations, yaw, pitch and roll with respect to a point of the dorsum or palm of the hand. The modelling device includes a detector for detecting a position and orientation of each of the first and second sensors. The modelling device also includes a storage for storing a first distance between said point and a first joint of the glove finger corresponding to a metacarpal-phalangeal joint of the finger, a second distance between the first joint and a second joint of the glove finger corresponding to a proximal interphalangeal joint of the finger, a third distance between the second joint and a third joint of the glove finger corresponding to a distal interphalangeal joint of the finger, and a fourth distance between the third joint and the first sensor. The modelling device is further provided with a calculator for calculating a position and orientation of each of the three joints on the basis of the stored first to fourth distances, the detected position and orientation of the first sensor, and the detected position and orientation of the second sensor.

According to the present invention, it is possible to model a position and orientation of a hand preferably without placing additional sensors to detect the positions and orientations of the metacarpal-phalangeal joint, the proximal interphalangeal joint, the distal interphalangeal joint of the finger.

### BRIEF DESCRIPTION OF DRAWINGS

FIG. 1 shows a human hand and its 27 bones;

FIG. 2 shows a measuring part of a modelling system according to a first embodiment of the present invention;

FIG. 3 shows an exemplary measurement volume within which a hand is to be placed;

FIG. 4 shows a coordinate system referenced to the field generator and a cubic measurement volume;

FIG. 5 shows a coordinate transformation;

FIG. 6 shows first sensors and a second sensor placed on a hand, joints and vectors used for hand-modelling;

FIG. 7 is a perspective view of a 5 DOF (degrees of freedom) magnetic sensor;

FIG. 8 shows a drawing to explain a calculation according to the first embodiment;

FIG. 9 shows an image of a real hand with sensors fixated with tapes and a modelled hand displayed on a monitor;

FIG. 10A shows a perspective view of the modelled hand;

FIG. 10B shows a side view of the modelled hand;

FIG. 11 shows sensors placed on an arm, joints and vectors used for arm-modelling according so a third embodiment of the present invention;

FIG. 12 shows other examples of sensor placement; and

FIG. 13 shows an example of sensor placement for optical tracking technologies.

### BEST MODES FOR IMPLEMENTING THE INVENTION

With reference to the drawings, preferred embodiments of the preserve invention will be explained below.

### First Embodiment

### Configuration

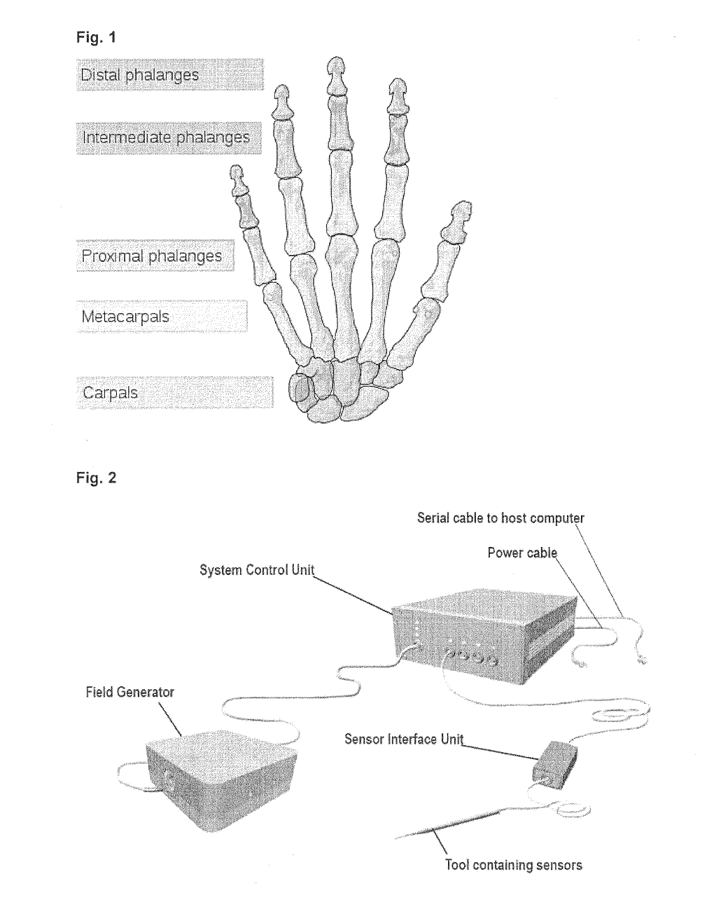

Referring to FIG. 2, the modelling system of the present embodiment includes a tool having a plurality of sensors to be attached to the finger and a separate modelling device, and uses an electro-magnetic principle to track hand and finger movements. In other words, the sensors to be placed on the fingers are sensor coils to which a varying magnetic field is applied and a resultant voltage is outputted to the modelling device.

As one example of such a modelling system a Aurora measurement system developed by Northern Digital Inc., Waterloo, Canada may be used. The measurement system may have a sampling rate of 40 Hz per sensor. A serial interface (Recommended Standard 232) may be used to transfer data from the system to a host computer with a maximum data rate of 115 kBaud.

The modelling system includes a field generator, a system control unit (SCU), sensor coils and a host computer (not shown), and may further include a sensor interface unit (SIU). The SCU or other power source provides power to the field generator, which in turn produces a series of varying magnetic fields, creating a predetermined volume of varying magnetic flux. Sensors connected to the SCU, via the SIU, are induced by the varying magnetic fields of the field generator. The SIU converts the voltages induced by the sensors, into digital data that is processed by the SCU to calculate the position and orientation of each of the sensors. On request of the host computer, a package including information of all the sensors may be prepared and sent over a device interface (RS 323) to the host computer.

Instead, the sensors or SIU may be provided (or connected) wish a wireless transmitter for transmitting a signal corresponding to the measured voltages or the calculated position and orientation of each of the sensors to the SIU or SCU (receiver), respectively, for further processing. Such a configuration may be preferably implemented in a system (e.g. game system) in which the movement of the hand/finger is displayed on a monitor.

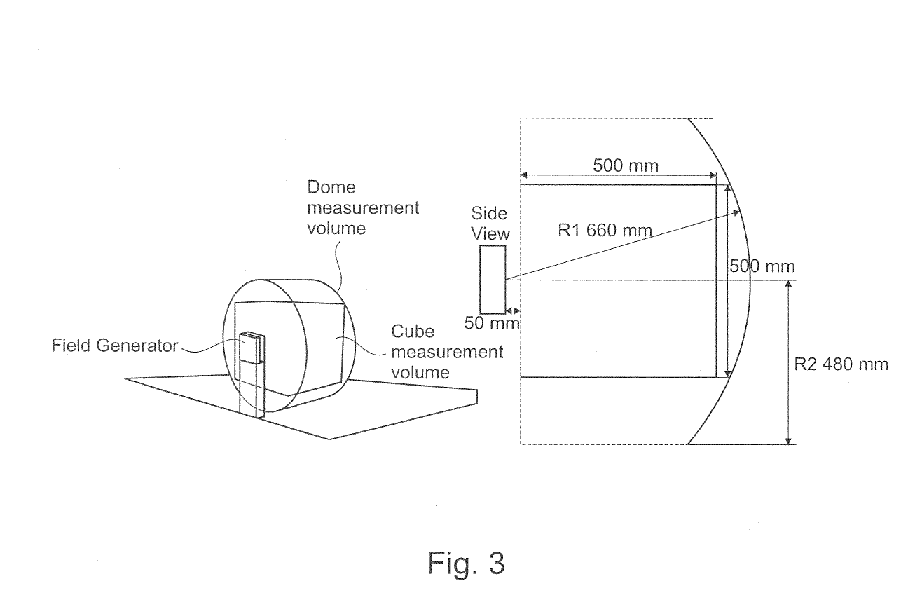

The field generator produces, for example, a cubic measurement volume (e.g. 500 mm×500 mm×500 mm) or a dome (R1=660 mm, R2=480 mm), as shown in FIG. 3.

In the present embodiment the sensor coil is an AUROR sensor coils by Northern Digital Inc. In one example, the sensor coil has a diameter of 0.5 mm and a length of 8 mm.

The modelling system of the present embodiment includes six magnetic sensors (five first sensors and a second sensor).

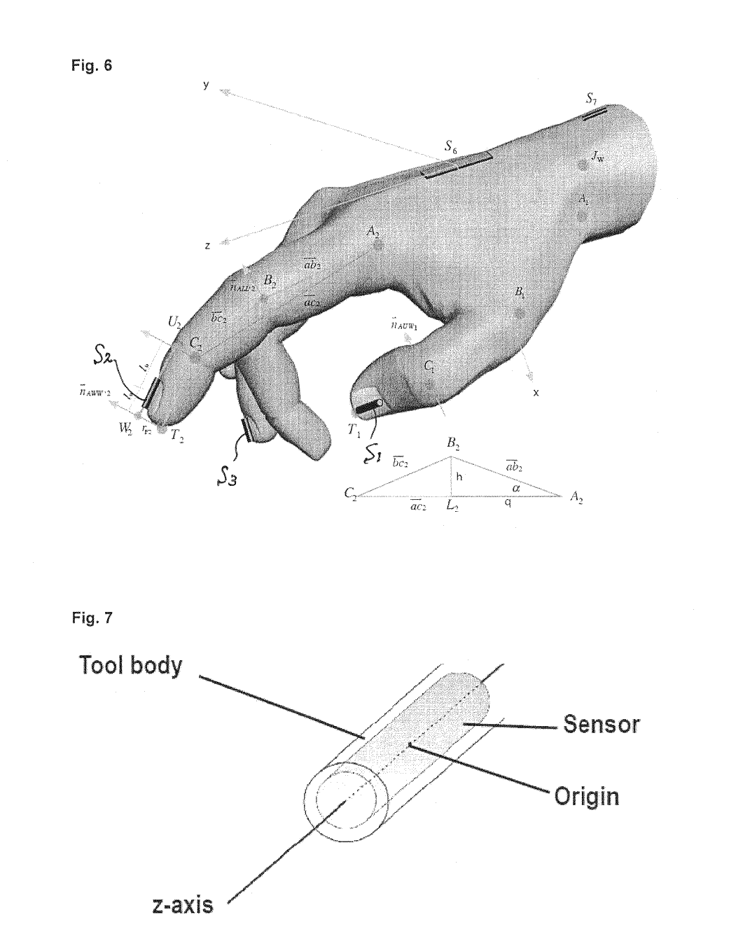

A sensor coil (each constituting the first sensor) is placed on a phalanx distalis of each of the digits and the thumb to provide 5 DOF (degrees of freedom) information: the Cartesian coordinates (x, y, z) (three translations) as well as the yaw angle and the pitch angle of the sensor (in FIG. 6 three sensor coils S₁, S₂, S₃ of the five are shown). For this purpose, the axis of the coil of the first sensor is placed along a longitudinal direction of the finger. It is noted that since roll information of each finger around the finger axis is unnecessary (because the fingers are rotated together with the remaining part of the hand; this roll information is detected by a second sensor as explained below), a sensor providing 5 DOF information is sufficient.

On other hand, two sensor coils constituting the second sensor are placed on the dorsum so as to provide 6 DOF information: the Cartesian coordinates (x,y,z) (three translations) as well as the yaw angle, the pitch angle and the roll angle of a point of the dorsum. That is, the second sensor provides information on a hand roll angle. For this purpose, the axes of the two sensor coils are placed in a geometrically defined position (e.g. orthogonal to each other; it is possible to obtain the roll information unless the axes are parallel to each other) so that the second sensor provides information on a roll of a point of the dorsum.

Together the two sensor coils present a plane in space that can be rotated in all directions around the above-mentioned point (which is an origin of the local coordinate system CV of the second sensor).

The two sensor coils are tracked separately, but the outputs are processed by the SCU to determine the 6 DOF information of the above-mentioned point). For this process the SCU will use a geometrical relationship of the two sensor coils saved in a memory-chip (SROM, serial read only memory) inside the SIU connector (FIG. 2). The geometry of the two sensor coils can be determined by a user. After the user has entered the needed information in a graphical user interface of the modelling system, a file is created. This file can be written to the SROM chip over a serial interface. During the initialization of the sensor coils the SROM is read to identify the origin.

### Hand-Modelling

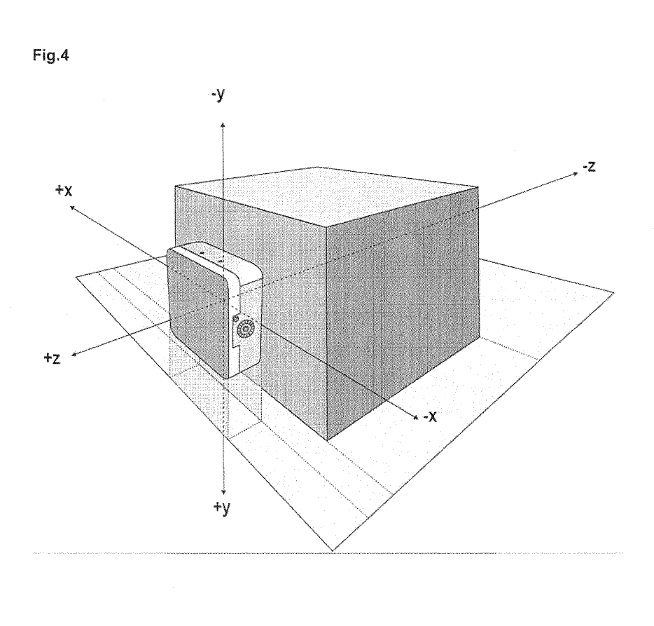

All calculations essential for hand-modelling are realized within the hardware configuration of the modelling system. The obtained position and orientation of the sensor will be referred to the coordinate system of the field generator (see FIG. 4).

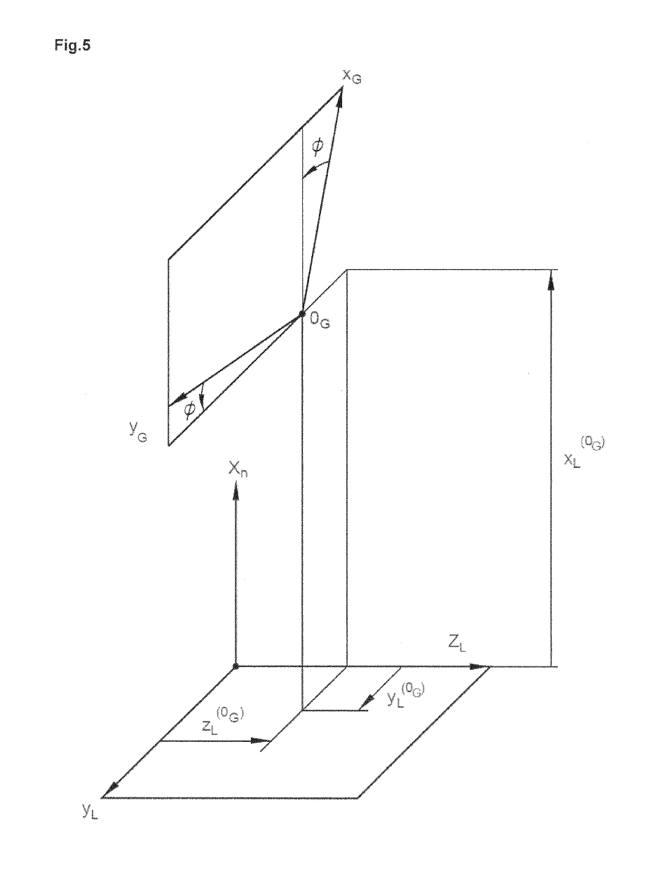

To compute and track one's hand, a new local reference point at the dorsum (backside of the hand's wrist) is defined (FIG. 5). For this reason the 6 DOF sensor (second sensor) will be placed there. The dorsum of the hand is the best location for the reference sensor because the relative distance to the metacarpal phalangeal joints does not change. The importance of this condition will become clearer in the following calculations.

It is to be noted that the 6 DOF sensor may be arranged on a palm of the hand instead of on the dorsum. Furthermore, the second sensor may not necessarily be placed directly on the dorsum or palm (i.e. the second sensor is spaced a distance away above the dorsum or below the palm) because the distance between the second sensor and a certain point of the dorsum or palm is constant, so that using the 6 DOF information of the sensor, the position of said point on the dorsum or palm and the orientation of the hand (the orientation of the second sensor is identical to that of the hand even if the second sensor is spaced away from the dorsum or palm) can still be obtained.

Here the field generator's coordinate system is called a global coordinate system while the hand's coordinate system a local coordinate system C_{L}. Point S is represented in coordinate system C_{G} by the position vector

r_{G}=[x_{G}, y_{G}, z_{G}, 1]^{T}

The same point S can be determined in coordinate system C_{L} by the position vector

r_{L}=[x_{L}, y_{L}, z_{L}, 1]^{T}

with the Matrix equation

r_{L}=M_{LG}r_{G}

Matrix M_{LG} is represented by

$${M}_{LG} = [ \begin{matrix}cos ( ) & cos ( ) & cos ( ) & {x}_{L}^{( {O}_{G} )} \\ cos ( ) & cos ( ) & cos ( ) & {y}_{L}^{( {O}_{G} )} \\ cos ( ) & cos ( ) & cos ( ) & {z}_{L}^{( {O}_{G} )} \\ 0 & 0 & 0 & 1\end{matrix} ]$$

O_{G} and O_{L} are the origins of the “global” and the “local” coordinate system (FIG. 5); subscript LG designation M_{LG} indicates that the transformation is performed from C_{G} to C_{L}.

In this way the global coordinates from the sensors {S_{L}_{₁}, S_{L}_{₂}, . . . , S_{L}_{₅}} mounted on the phalanx distalis of digits and thumb are transformed to the local coordinate system of the reference sensor s_{G}_{ᵢ}=[x_{G}_{ᵢ}, y_{G}_{ᵢ}, z_{G}_{ᵢ}, 1]^{T}.

s_{L}_{ᵢ}=M_{LG}s_{G}_{ᵢ} ∀i={1, 2, . . . , 5}

From now on equations refer to the local coordinate system. Therefore subscripts indicating the coordinate frame are omitted.

The whole hand can be described by the wrist-joint (J_{w}), the five metacarpal-phalangeal joints {A₁, A₂, . . . , A₅}, the five proximal-interphalangeal joints {B₁, B₂, . . . , B₅} and the distal-interphalangeal joints {C₁, C₂, . . . , C₅} as shown in FIG. 6. Each of these variables represents the joint's local coordinates [x, y, z]^{T}

As mentioned before, the distance between S₆ (origin of the local coordinate system of the second sensor) and the metacarpal-phalangeal joints are assumed to be constant. Therefore {A₁, A₂, . . . , A₅} can be determined by measuring their distances to S₆.

With the given transformed points {S_{L}_{₁}, S_{L}_{₂}, . . . , S_{L}_{₅}} and the measured points {A₁, A₂, . . . , A₅} the remaining points {C₁, C₂, . . . ,C₅} and {B₁, B₂, . . . , B₅} can be calculated:

For this, a third coordinate system C_{S} is determined, which is the local coordinate system of the first sensor, having an origin in its center as illustrated in FIG. 7. X and Y—axes of the 5 DOF sensors coordinate system are not determined. Because transformations were only done in the 2-axis this limitation can be ignored.

Two points along the sensor's z-axis are introduced according to FIG. 6.

Uₛ=[0, 0, −l_{U}]^{T} l_{U} . . . distance from origin to U

Wₜ=[0, 0, l_{w}]^{T} l_{w} . . . distance from origin to W

These points are then transformed to the hand's local coordinate system C_{L}.

U_{L}_{ᵢ}=M_{LS}I_{S}_{ᵢ} ∀i={1, 2, . . . , 5}

W_{L}_{ᵢ}=M_{LS}W_{S}_{ᵢ} ∀i={1, 2, . . . 5}

|\vec{uw}ᵢ| does have the same length as the distal phalanx of finger i. Instead of having the a vector pointing from U to W, it would be more accurate for the following calculations to have the same vector pointing from C to T; T is defined as the finger tip (FIG. 6).

Because A, U and W are on one plane, the vector normal to this plane \vec{n}_{AUW} can be calculated.

$${\vec{n}}_{AUW} = \frac{\vec{a u} \times \vec{uv}}{\vert \vec{a u} \times \vec{uv} \vert}$$

A new point W′=W+\vec{n}_{AUW} can be used to find the vector normal to the plane described by the points A, w and W′. This new vector \vec{n_{AUW′}} is orthogonal to \vec{uwᵢ} and is part of the plane A, U, W and can be used to shift the points U and W parallel into the center of the finger to get the point C and T.

Tᵢ=Wᵢ+\vec{n}_{AWW′}ᵢ·r_{F}_{ᵢ}

Cᵢ=Uᵢ+\vec{n}_{AWW′}ᵢ·r_{F}_{ᵢ}

r_{F}_{ᵢ} . . . radius of finger i

The fact that the proximal-interphalangeal joints have only one degree of freedom allows to calculate point B in 3D-space. In other words, point A, B and C are always moving within the same plane defined by these three points. To get point B the triangle built by A, B and C is first calculated in 2D-space. The points A, C as well the measured length |\vec{ab}| (proximal phalanx) and |\vec{bc}| (intermediate phalanx) are known. Furthermore the distance |\vec{ac}| can be calculated. Using the law of cosines the angle

$$α = arccos ( \frac{{\vert \vec{ab} \vert}^{2} + {\vert \vec{a c} \vert}^{2} - {\vert \vec{bc} \vert}^{2}}{2 \cdot \vert \vec{ab} \vert \cdot \vert \vec{a c} \vert} ) and$$

$$h = sin ( α ) \cdot \vert \vec{ab} \vert$$

$$q = cos ( α ) \cdot \vert \vec{ab} \vert$$

can be calculated (according to FIG. 6). Therefore point L is

L=A+\vec{e_{ac}}·q

There are endless solutions for B, all of them orthogonal to \vec{ac} around point L. To find the solution on the plane the normal vector \vec{n}_{AUW} is used to calculate L′.

L′=L+\vec{n}_{AUW}

The vector normal to the plane of point A, L and L′ is

$${\vec{n}}_{{ALL}^{′}} = \frac{\vec{al} \times \vec{{al}^{′}}}{\vert \vec{al} \times \vec{{al}^{′}} \vert}$$

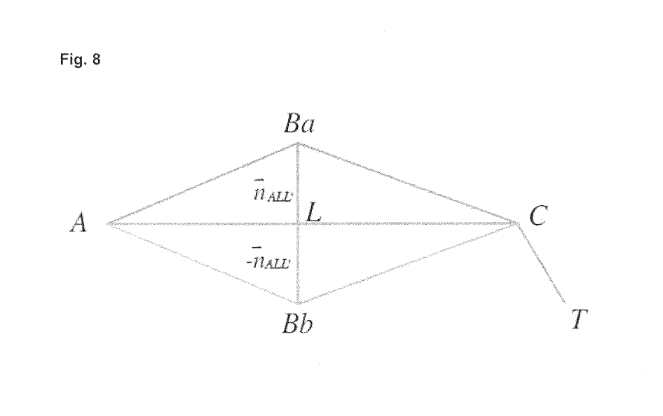

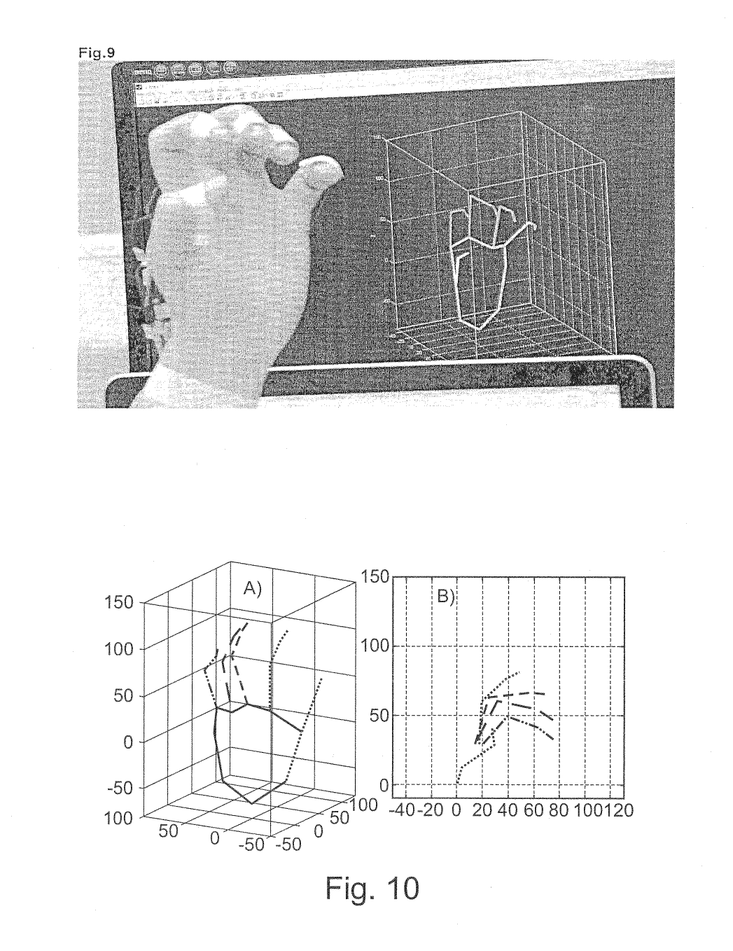

Two solutions on plane ALL′ can be found as illustrated in FIG. 8.

Bₐ=Lᵢ+\vec{n}_{ALL′}_{ᵢ}·h

B_{b}=Lᵢ−\vec{n}_{ALL′}_{ᵢ}·h

During natural finger movements the flexion of the intermediate phalanges are associated with the flexion of the distal phalanges. The same is true for extension. This fact can be used to find the anatomically correct solution for the intermediate phalangeal join position, (point B in FIG. 8). In other words, one solution (point Ba or Bb) with a greater distance no the finger tip (point T in FIG. 3) is selected.

An operation of the modelling system will now be explained.

The first sensor is attached on a phalanx distalis of each finger while the second sensor is attached on the dorsum of the hand.

The necessary information on the finger of a user is measured. Specifically, a first distance between a point (origin of the second sensor) on the dorsum of the hand and the metacarpal-phalangeal joint A of the finger, a second distance between the metacarpal-phalangeal joint A and the proximal interphalangeal joint B, a third distance between the proximal interphalangeal joint B and the distal, interphalangeal joint C, and a fourth distance between the distal interphalangeal joint C and the first sensor are measured. The second distance and the third distance may be measured before attaching the sensors.

Next, a varying magnetic field is generated so that the Voltages induced in the sensors are sent as digital data (generated by she SIU) to the SCU. On the basis of the digital data, the SCU detects a position and orientation of each of the first sensors and the second sensor at intervals (e.g. sampling rate of 40 Hz). When receiving a signal from the SCU, the host computer calculates a position and orientation of each of the three joints on the basis of the measured first to fourth distances of each finger, the detected position and orientation of tine first sensor of each finger, and the detected position and orientation of the second sensor.

The calculated position and orientation of each of the metacarpal-phalangeal joint A, the proximal interphalangeal joint B, and the distal interphalangeal joint C of each finger is supplied to a driver for driving the monitor, in addition to the detected position and orientation of each sensor.

A model of the hand is displayed on the monitor on the basis of the supplied information. A region between the adjacent joints may preferably be displayed as a line connecting the joints, as shown in FIGS. 3 and 10.

### Second Embodiment

Next, a second embodiment of the present invention is explained. A modelling system according to the present embodiment includes a glove with sensors, instead of separate sensors to be attached to the hand.

Specifically, the glove has a first sensor on a portion of each glove finger corresponding to a phalanx distalis of a finger, and a second sensor at a position that is fixed on a portion (which may preferably be located at a non-visible place inside the glove) of the glove finger corresponding to a dorsum or palm of the hand. The first and second sensors are identical to those in the first embodiment. In one example, the first sensor is provided on a glove portion corresponding to the fingernail.

The hardware configuration is similar to that of the first embodiment shown in FIG. 2.

However, in the second embodiment, there is provided a storage (for example in the host computer) for storing a first distance between a point of the dorsum (the second sensor provides 6 DOF information on said point) and a first joint of the glove finger corresponding to a metacarpal-phalangeal joint of the finger, a second distance between the first joint and a second joint of the glove finger corresponding to a proximal interphalangeal joint of the finger, a third distance between the second joint and a third joint of the glove finger corresponding to a distal interphalangeal joint of the finger, and a fourth distance between the third joint and the first sensor.

The SCU is adapted to detect a position and orientation of each of the first and second sensors based on the voltages from the sensors (i.e. digital data from the SIU).

The host computer is further adapted to calculate a position and orientation of each of the three joints of the glove fingers on the basis of the stored first to fourth distances, the detected position and orientation of each of the first sensors, and the detected position and orientation of the second sensor.

The operation (calculation of the position and orientation of each of the three joints) of the modelling system of the present embodiment is similar to that of the first embodiment, and therefore the explanation thereof is omitted.

### Third Embodiment

### Arm-Modelling

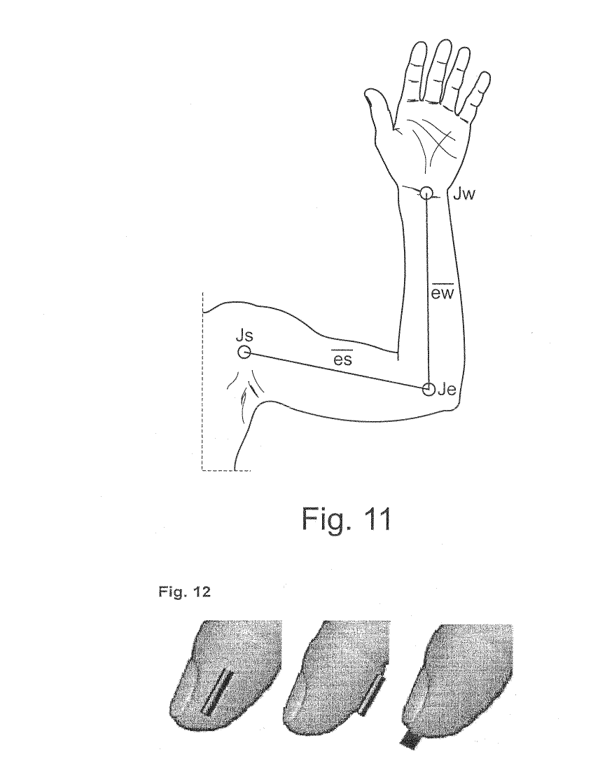

Referring to FIG. 11, a third embodiment of the present invention is explained. In the third embodiment, in addition to the hand-modelling an arm-modelling takes place. Namely, the positions and orientations of a shoulder joint Js, an elbow joint Je and a wrist joint Jw will be determined. These joints are assumed to be on the same plane. Also, the elbow joints Je and wrist joints Jw are preferably on a rotation axis of the forearm.

As explained below, an additional sensor (sensor coil) S₇ to be placed on a forearm is needed to calculate positions and orientations of the entire arm. The axis of the sensor coil is placed along a longitudinal direction of the forearm.

A calculation method to be performed by the host computer (FIG. 2) will now be explained.

Assuming the shoulder position to be constant (e.g. the user sits on a chair), the position of the shoulder joint Js is determined. The length of the forearm is measured before the arm modelling.

In the coordinate system C_{L} of the sensor S₆, the position of wrist joint J_{W} is described by the measured x-, y- and z-distances from the wrist joint to the reference sensor that is the second sensor S₆ (FIG. 6). Here they are called the distances wₓ, w_{y} and w_{z}.

Jw=[0+wx,0+wy,0+wz]^{T}

The point gets transformed to the global coordinate system:

Jw_{G}=M_{LG}⁻¹·Jw

The additional sensor S₇ is used to determine a new coordinate system C_{w} that has the orientation of S₇ and its origin at the wrist joint point Jw. The rotation-matrix M_{w} is therefore defined by the orientation of S₇ and the position of Jw.

The position of the elbow joint Je in the coordinate system C_{w} is:

Je_{w}=[0,0,−lfa]

where lfa is the length of the forearm. The position of the elbow joint Je is then transformed into the global coordinate system.

Je_{G}=M_{w}·Je_{w}

The orientation of the elbow joint Je is the same as that of the sensor S₇. It is noted that the roll angle of the sensor S₇ is determined on the basis of the roll angle of the second sensor S₆ (since the hand and the arm rotate together around the forearm axis).

As such, the host computer obtains the position of the shoulder joint Js as well as the position and orientations of the wrist joint Jw and the elbow joint Je. This may be further processed, for example, to display the arm model together with the hand model.

Although the additional sensor S₇ may be located at an arbitrary position at the forearm as long as the yaw and pitch of the forearm is calculated, it is preferable to locate the sensor S₇ close to the sensor S₆ because the field generator provides a limited range of magnetic field.

In the same manner as the second embodiment, a glove may be provided with the additional sensor S₇. In this case, the sensor S₇ will have to be located close to the sensor S₆.

Although in the present embodiment the sensor coil is used as the third sensor S₇ that is the same as the first sensor, i.e. 5 DOF sensor, it is sufficient that the third sensor on the forearm provides information on 2 DOF that correspond to yaw and pitch.

The modelling system and method of the present invention has been explained with reference to the preferred embodiments. However, it should be understood that various changes, substitutions and alternations may be made without departing from the scope of the invention as defined by the appended claims.

For example, in the first and second embodiments the first sensor (finger-sensor) is placed on the fingernail or on a glove portion corresponding to the fingernail. However, the first sensor may be placed on a side of the phalanx-distalis, below the phalanx-distalis, or on a finger tip as shown in FIG. 12.

The first sensors may not necessarily be provided corresponding to all the fingers.

In the first to third embodiments, sensor coils for electro-magnetic tracking are used. Other sensors such as optical sensors, acceleration sensors, or gyroscopes may be used to provide 5 DOF information of 6 DOF information.

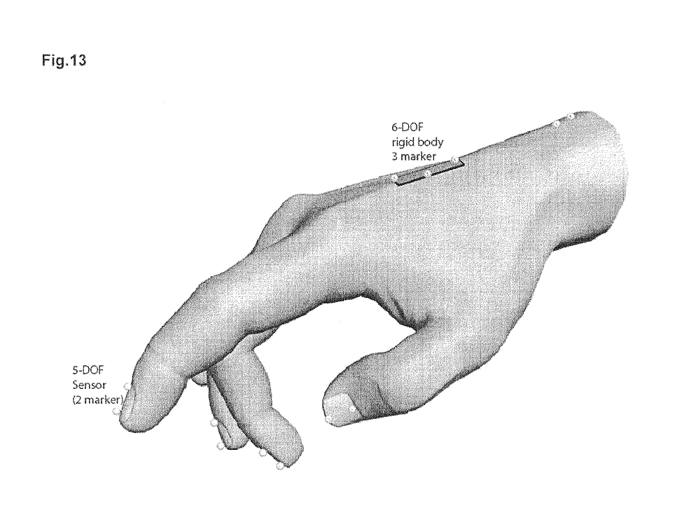

For example, an optical tracking system using reflecting (passive) markers or active markers that can be detected in 3-D space as shown in FIG. 13, may be used. The combination of three markers with constant distance to each other (3 positions in 3-D space) allows acquiring 6 DOF, two markers with constant distance to each other allows acquiring 5 DOF respectively.

Images may be used which are captured from one or mere cameras calibrated to provide overlapping projections to compute the position (coordinates) of the markers in space. The markers are positioned so as to guarantee a sufficient difference in comparison to the rest of the captured image to find their positions using video filtering techniques.

However, the use of magnetic sensors as in the first to third embodiments is more advantageous in that in case of the optical tracking system a so-called line of sight is needed.

More than two types of sensors may be used (e.g. an acceleration sensor is used as the third sensor providing at least yaw and pitch information while sensor coils are used as the first and second sensors).

In the first embodiment, the distance between the distal interphalangeal joint C and the first sensor is defined, as lu with respect to a surface direction and r_{F} with respect to a radius direction, so that the joints A, B, C is positioned on an rotation axis of the finger. Although placing the joints on the finger axis allows a more accurate modelling of the position and orientation of the joints A, B, C, it may be possible to define the distance between the distal interphalangeal joint C and the first sensor in a different way (e.g. three joints or joint points are assumed to be not on the finger axis but on the surface of the finger).

The same can be said of the elbow joint Je and the wrist joint Jw in the third embodiment. That is, the elbow and wrist joints may be defined in a plane, which does not contain the forearm axis (although placing the two joints on the forearm axis allows a more accurate modeling of the arm).

In the first embodiment, the distance between the point on the dorsum and the metacarpal-phalangeal joint is measured. However, the following method may be used to evaluate the position of the metacarpal-phalangeal joint so that the measurement of the above-mentioned distance can be omitted (which may otherwise take place every time when the second sensor is attached).

Before the hand motion modeling is started, the x,y and z-position of the metacarpal-phalangeal joints will be found. For this purpose, the user will place his/her hand on a flat surface, such as table, within a measurement volume (e.g., of the magnetic field generator) with all fingers stretched. When the fingers are stretched the angle between the finger joints are assumed to be zero.

In the coordinate system Cₛ of the first sensors the position of the metacarpal-phalangeal joints is:

Aₛ_{ᵢ}=[0,0,0−(lu+1\vec{bc}ᵢl+l\vec{ab}ᵢl]

As such, the position of the metacarpal-phalangeal joint A is then transformed to the local coordinate system of the first sensor in the same manner as for point Uᵢ and Wᵢ. Further, the joint position is converted to the global coordinate system (i.e. the position and orientation of the first and second sensors are detected) and further to the local coordinate system of the second sensor S₆. After that, the hand motion modelling is started.

As a result, the position of the metacarpal-phalangeal joint A relative to the second sensor S₆ can be obtained. Therefore, after the hand motion modelling is started, it is possible to follow the position of the metacarpal-phalangeal joint A.

### INDUSTRIAL APPLICABILITY

The present invention can be applied to a wide range of fields in which modelling of a hand/arm is needed.

For example, information obtained from the hand is used to control a robotic hand. That is, a hand motion is tracked and translated into control signals to move the robotic hand.

Sensors or a glove with sensors may be attached to a non-human primate for a training purpose or a study on how the brain is encoding and planning grasp movements.

Furthermore, the modelling method and system may be used for a hand/arm animation in a film industry or in computer games.

1. A method for modelling a position and orientation of a hand, comprising the steps of:
attaching at least a first sensor on a phalanx distalis of a finger, wherein said first sensor is adapted to provide information on at least five degrees of freedom that correspond to three translations, yaw and pitch;
placing a second sensor at a fixed position relative to a dorsum or palm of the hand, wherein said second sensor is adapted to provide information on at least six degrees of freedom that correspond to three translations, yaw, pitch and roll with respect to a point (Se) of the dorsum or palm of the hand;
detecting a position and orientation of each of the first and second sensors;
measuring a first distance between said point (S6) and a metacarpal-phalangeal joint (A) of the finger, a second distance between the metacarpal-phalangeal joint (A) and a proximal interphalangeal joint (B), a third distance between the proximal interphalangeal joint (B) and a distal interphalangeal joint (C), and a fourth distance between the distal interphalangeal joint (C) and the first sensor; and
calculating a position and orientation of each of the three joints on the basis of the measured first to fourth distances, the detected position and orientation of the first sensor, and the detected position and orientation of the second sensor.

2. A method according to claim 1, wherein the first sensor comprises a sensor coil with its axis being placed along a longitudinal direction of the finger, and the second sensor comprises two sensor coils with their axes being placed in a geometrically defined position to each other so that the second sensor provides information on a roll of said point (S6),
further comprising the step of:
generating a varying magnetic field so that the first and second sensors induce voltages, so that at the detection step the position and orientation of each of the first and second sensors is detected based on the induced voltages.

3. A method according to claim 1, wherein the second sensor is arranged on the dorsum or palm of the hand.

4. A method of providing a signal to a processing device, comprising the steps of modelling a position and orientation according to one of the preceding claims and further comprising the step of generating at least one signal according to the calculated position and orientation.

5. A system for modelling a position and orientation of a hand, comprising:
a glove with glove fingers, comprising
at least a first sensor on a portion of the glove finger corresponding to a phalanx distalis of a finger, wherein said first sensor is adapted to provide information on at least five degrees of freedom that correspond to three translations, yaw and pitch; and
a second sensor at a position that is fixed on a portion of the glove finger corresponding to a dorsum or palm of the hand, wherein said second sensor is adapted to provide information on at least six degrees of freedom that correspond to three translations, yaw, pitch and roll with respect to a point of the dorsum or palm of the hand, and
a device comprising
a detector for detecting a position and orientation of each of the first and second sensors;
a storage for storing a first distance between said point and a first joint of the glove finger corresponding to a metacarpal-phalangeal joint of the finger, a second distance between the first joint and a second joint of the glove finger corresponding to a proximal interphalangeal joint of the finger, a third distance between the second joint and a third joint of the glove finger corresponding to a distal interphalangeal joint of the finger, and a fourth distance between the third joint and the first sensor; and
a calculator for calculating a position and orientation of each of the three joints on the basis of the stored first to fourth distances, the detected position and orientation of the first sensor, and the detected position and orientation of the second sensor.

6. A system according to claim 5, wherein the first sensor comprises a sensor coil with its axis being placed along a longitudinal direction of the glove finger, and the second sensor comprises two sensor coils with their axes being placed in a geometrically defined position to each other so that the second sensor provides information on a roll of said point, further comprising:
a generator for generating a varying magnetic field so that the first and second sensors induce voltages, thereby allowing the detector to detect the position and orientation of each of the first and second sensors based on the induced voltages.

7. A system according to claim 5, further comprising a generator for generating at least one signal according to the calculated position and orientation.

8. A system according to claim 5, further comprising a wireless transmitting device for transmitting an output of the first sensor and/or the second sensor to a receiver.

9. A method for modelling a position and orientation of a hand, comprising the steps of:
attaching at least a first sensor on a phalanx distalis of a finger, wherein said first sensor is adapted to provide information on at least five degrees of freedom that correspond to three translations, yaw and pitch;
placing a second sensor at a fixed position relative to a dorsum or palm of the hand, wherein said second sensor is adapted to provide information on at least six degrees of freedom that correspond to three translations, yaw, pitch and roll with respect to a point (S6) of the dorsum or palm of the hand;
measuring a first distance between a metacarpal-phalangeal joint (A) and a proximal interphalangeal joint (B), a second distance between the proximal interphalangeal joint (B) and a distal interphalangeal joint (C), and a third distance between the distal interphalangeal joint (C) and the first sensor;
calculating a position of a metacarpal-phalangeal joint (A) relative to the first sensor in a state that the finger is stretched, on the basis of the first to third distances;
detecting a position and orientation of each of the first and second sensors; and
calculating a position and orientation of each of the three joints on the basis of the measured first to third distances, the calculated, relative position of the metacarpal-phalangeal joint (A), the detected position and orientation of the first sensor, and the detected position and orientation of the second sensor.

10. A method according to claim 1, further comprising steps of modelling a position and orientation of an arm, said steps comprising:
attaching a third sensor (S7) on a forearm, wherein the third sensor is adapted to provide information on at least two degrees of freedom that correspond to yaw and pitch;
providing a position of a shoulder joint (Js);
detecting an orientation of the third sensor (S7) on the basis of an output from the third sensor (S7) and detected roll information of the second sensor (S6);
obtaining an orientation of a wrist joint (Jw) and an elbow joint (Je) on the basis of the detected orientation of the third sensor (S7);
measuring a fifth distance between the wrist joint (Jw) and the second sensor (S6);
calculating a position of the wrist joint (Jw) on the basis of the measured fifth distance and the detected position of the second sensor (S6);
measuring a length of the forearm; and
calculating a position of the elbow joint (Je) on the basis of the measured length of the forearm, the detected orientation of the third sensor (S7) and the calculated position of the wrist joint (Jw).

11. A system according to claim 5, further adapted to model a position and orientation of an arm, wherein
the glove further comprises a third sensor (S7) on a glove portion corresponding to a forearm of the arm, wherein the third sensor is adapted to provide information on at least two degrees of freedom that correspond to yaw and pitch,
said detector is adapted to detect yaw and pitch information of the third sensor (S7);
said calculator is adapted to calculate an orientation of the third sensor (S7) on the basis of the detected yaw and pitch information of the third sensor (S7) and detected roll information of the second sensor (S6);
said storage is adapted to store a position of a shoulder joint (Js), a length of the forearm and a fifth distance between a wrist joint (Jw) and the second sensor (S6);
said calculator is adapted to obtain an orientation of the wrist joint (Jw) and an elbow joint (Je) on the basis of the detected orientation of the third sensor (S7), to calculate a position of the wrist joint (Jw) on the basis of the stored fifth distance and the detected position of the second sensor (S6), and to calculate a position of the elbow joint (Je) on the basis of the stored length of the forearm, the detected orientation of the third sensor (S7) and the calculated position of the wrist joint (Jw).
